(19) United States
(12) Patent Application Publication
(10) Pub. No.: US 2003/0044022 A1
(43) Pub. Date: Mar. 6, 2003

(54) Mobile terminal equipment

(75) Inventor: Takayasu Ishida, Shizuoka (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/224,991

(22) Filed: Aug. 21, 2002

(30) Foreign Application Priority Data
Sep. 4, 2001 (JP) 267568/2001

(51) Int. Cl. H04R 29/00

(52) U.S. Cl. 381/58; 381/59

(57) ABSTRACT

The present invention provides a mobile terminal equipment having local circuits susceptible to the influence of magnetic field fluctuation, which is capable of reducing phase shift of the local circuit arrangement even when a magnetic field fluctuation occurs. In the mobile terminal equipment, when the speaker is activated to emit a sound at a specific fixed frequency, a phase shift which is generated in the PLLIC due to the influence of an electromotive force produced in the VCO accompanying with a magnetic field fluctuation caused by fine vibration of the speaker magnet section, is reduced by performing fine adjustment of the frequency of the VCTCXO, thus the deterioration of modulation accuracy characteristics during the sound emission of the speaker is restrained.

### BACKGROUND OF THE INVENTION

1. Field of the Invention

The present invention relates to a mobile terminal equipment and, more particularly, to a mobile terminal equipment having a local circuit arrangement susceptible to the influence of magnetic field fluctuation.

2. Description of the Prior Art

Recently, on the basis of the user's need for improving in operability and so on, a trend toward a smaller mobile terminal equipment such as a cellular telephone set or the like has progressed, and such structure that a control section, a notifying section and the like are positioned closely to a radio section within the mobile terminal equipment has been getting adopted.

As a result, when a mobile terminal equipment is designed without taking into consideration the layout of the local circuits of the radio section and the speaker in the mobile terminal equipment, vibration of the speaker magnet section causes a fluctuation of magnetic field during the sound emission of the speaker. The local circuits are subjected to this influence causing a phase shift of the local circuits during the sound emission of the speaker resulting in deterioration of the modulation accuracy. This may sometimes result in communication drop.

FIG. 1 is a block diagram illustrating a local circuit arrangement in a conventional mobile terminal equipment.

A control section 401 transmits frequency-setting data, which is used for data transmission/reception, from a CPU section 401A to a PLLIC (Phase Lock Loop IC) 403.

The PLLIC 403 compares, in accordance with the received frequency-setting data, the phase of frequency obtained by dividing a reference CLK from a VCTCXO 402 within the PLLIC 403 with that of frequency obtained by dividing an output frequency of a VCO 405 within the PLLIC 403, and then alters a voltage value applied to the VCO 405 via a low pass filter 404 so that the phases coincide with one another.

The output frequency of the VCO 405 is supplied to a receiving section 409 or a transmitting section 410, and is used as a local frequency for data transmission/reception.

When a speaker 408 is activated to emit a sound in order to give a notice of an alarm or an arrival of information, in the case where the notice is given at a fixed frequency, a sound frequency generated by a waveform generation circuit 401C is amplified by a speaker amplifier 406 to activate the speaker 408 to emit a sound.

In the case where the notice is given, not at a fixed frequency but by means of a melody or the like, sound data is transferred to a sound source IC 407 from the CPU section 401A and is amplified by the speaker amplifier 406 to activate the speaker 408 to emit a sound.

FIGS. 2A-2E are diagrams showing the state of signals in the respective sections of the circuit arrangement shown in FIG. 1 wherein FIG. 2A shows the output 501 of the waveform generation circuit 401C shown in FIG. 1, FIG. 2B shows the output 502 of a D/A converter 401B shown in FIG. 1, FIG. 2C shows the output 503 of the VCTCXO 402 shown in FIG. 1, FIG. 2D shows changes of magnetic flux in the VCO 405, which is generated when the speaker 408 shown in FIG. 1 is activated to emit a sound at a fixed frequency and FIG. 2E shows the output 505 of the VCO 405 shown in FIG. 1.

As shown in these figures, conventionally, when the speaker 408 is activated to emit a sound at a fixed frequency, the magnet section of the speaker 408 vibrates and, under the influence of it, a change of magnetic flux is caused at the VCO 405. As a result, the phase of the output 505 from the VCO 405 is altered.

An example of preventive measures against the influence of the magnetic field fluctuation as described above is to reduce the amount of the leak magnetic flux by providing a cover to the magnet section of the speaker. However, the preventive measures have such disadvantages that the cost and the weight thereof are increased.

Further, when the speaker and the local circuits are positioned more apart from one another to prevent the phase shift during the sound emission of the speaker, such a problem also occurs that the entire layout of the parts is influenced resulting in a difficulty in disposing them effectively.

### SUMMARY OF THE INVENTION

The present invention has been made to solve the above-described problems. An object of the invention is to provide a mobile terminal equipment having a local circuit arrangement susceptible to the influence of the magnetic field fluctuation, wherein the mobile terminal equipment is capable of reducing the phase shift of the local circuits even when a magnetic field fluctuation occurs.

In order to achieve the above-described object, the invention is characterized in that, for example, in a cellular telephone set, when a speaker is activated to emit a sound at a specific fixed frequency, a phase shift, which is generated in a PLL synthesizer circuit (hereinafter referred to as “PLLIC”) due to the influence of the electromotive force generated in a voltage controlled oscillator (hereinafter referred to as “VCO”) accompanying with a magnetic field fluctuation due to a fine vibration of a speaker magnet section, is reduced by finely controlling the frequency of a voltage controlled temperature compensated crystal oscillator (hereinafter referred to as “VCTCXO”) to restrain the deterioration of modulation accuracy characteristics during the sound emission of the speaker.

The local frequency specified by the control section, whose phase is compared with that of the frequency of the VCTCXO in the PLLIC, is maintained at the specified frequency by controlling the voltage applied to the VCO. Then, the local frequency is supplied to the receiving section and the transmitting section. In a configuration that the frequency of the VCTCXO can be controlled by means of voltage control from the control section, according to the invention, the voltage value to be applied to the VCTCXO is subjected to a control in which a specific offset value is turned ON/OFF in accordance with the operation cycle of the circuit that generates a waveform of the sound to reduce the phase shift at the PLLIC.

With this arrangement, since the phase error is not increased even when the speaker is actuated to emit a sound at a specific fixed frequency, such effect is obtained that a failure such as a communication drop due to the deterioration of modulation accuracy does not occur.

### BRIEF DESCRIPTION OF THE DRAWINGS

FIG. 1 illustrates a local circuit arrangement in a conventional mobile terminal equipment;

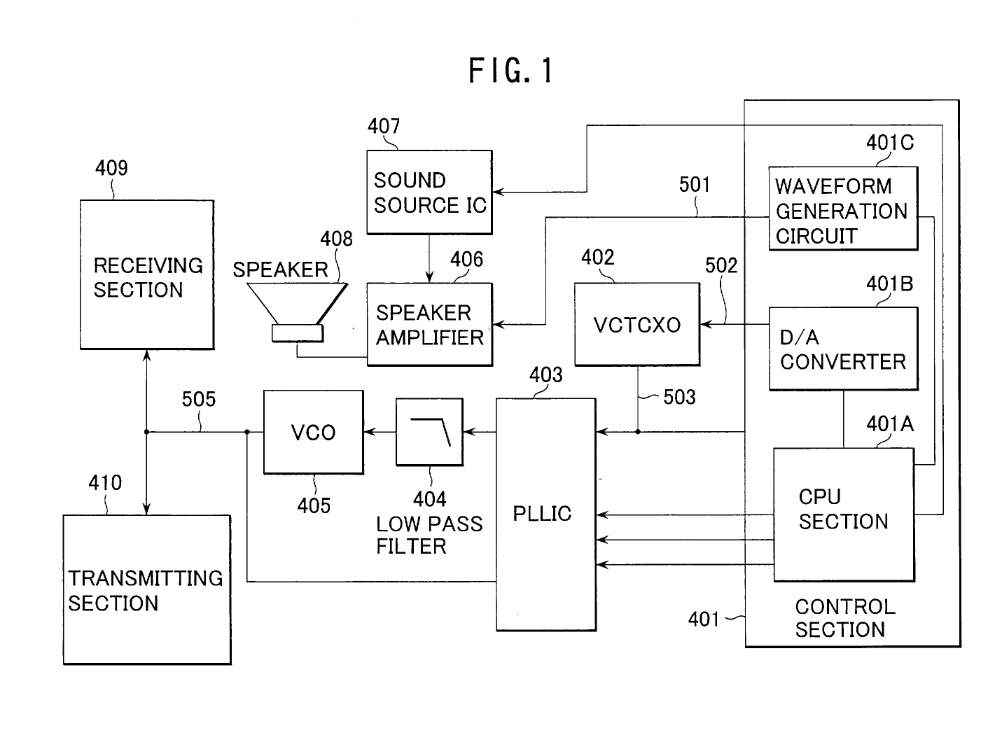

FIG. 2A shows the output 501 of the waveform generation circuit 401C shown in FIG. 1, FIG. 2B shows the output 502 of a D/A converter 401B shown in FIG. 1, FIG. 2C shows the output 503 of the VCTCXO 402 shown in FIG. 1, FIG. 2D shows changes of magnetic flux in the VCO 405, which is generated when the speaker 408 shown in FIG. 1 is activated to emit a sound at a fixed frequency and FIG. 2E shows the output 505 of the VCO 405 shown in FIG. 1;

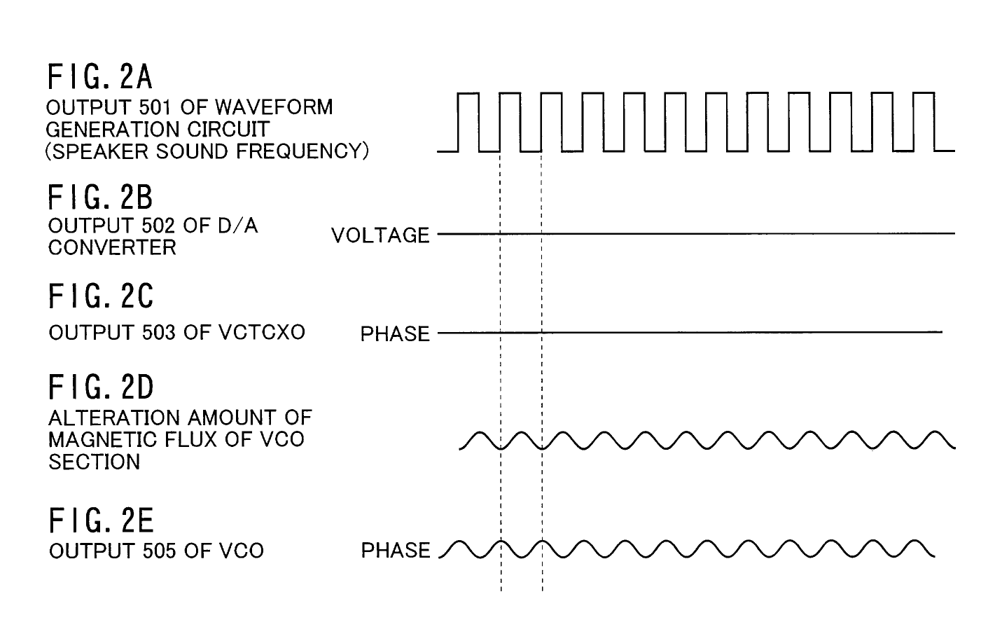

FIG. 3 illustrates a local circuit arrangement in a mobile terminal equipment according to an embodiment of the invention;

FIG. 4 illustrates details of the local circuits according to the embodiment shown in FIG. 3; and

FIG. 5A shows the output 301 of the waveform generation circuit 101C shown in FIG. 3, FIG. 5B shows the output 302 of a D/A converter 101B shown in FIG. 3, FIG. 5C shows the output 303 of a VCTCXO 102 shown in FIG. 3, FIG. 5D shows changes of magnetic flux in a VCO 105, which is generated when the speaker 108 shown in FIG. 3 is activated to emit a sound at a fixed frequency and FIG. 5E shows the output 305 of the VCO 105 shown in FIG. 3.

### DETAILED DESCRIPTION OF THE PREFERRED EMBODIMENT

The present invention will now be described in detail by referring to the drawings.

The invention is characterized in that, for example, in a cellular telephone set, when a speaker is activated to emit a sound at a specific fixed frequency, a phase shift which is caused in a PLL synthesizer circuit (hereinafter referred to as “PLLIC”) due to the influence of the electromotive force generated in a voltage controlled oscillator (hereinafter referred to as “VCO”) owing to a magnetic field fluctuation due to a fine vibration of the speaker magnet section, is reduced by finely controlling the frequency of a voltage controlled temperature compensated crystal oscillator (hereinafter referred to as “VCTCXO”) to restrain the deterioration of modulation accuracy characteristics during the sound emission of the speaker.

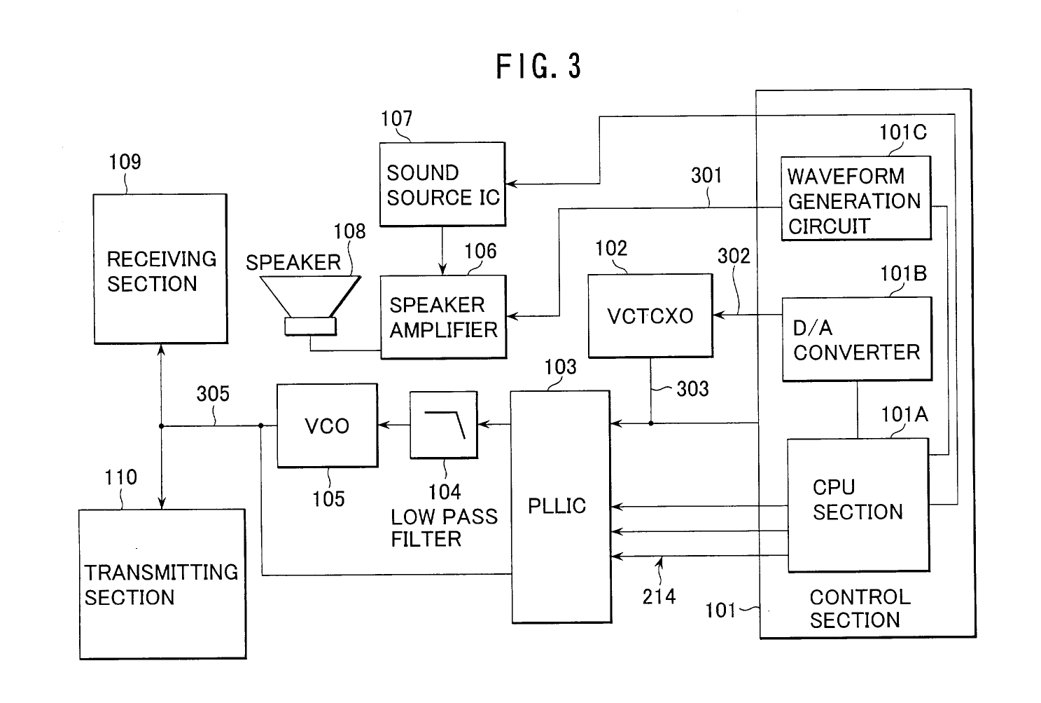

FIG. 3 shows illustrating local circuits of a mobile terminal equipment according to an embodiment of the invention.

The control section 101 transmits frequency-setting data, which is used for data transmission/reception, from a CPU section 101A to a PLLIC (Phase Lock Loop IC) 103.

The PLLIC 103 compares, in accordance with the received frequency-setting data, the phase of frequency obtained by dividing the reference CLK from a VCTCXO 102 within the PLLIC 103 with that of frequency obtained by dividing the output frequency of a VCO 105 within the PLLIC 103, and then alters the voltage value applied to the VCO 105 via a low pass filter 104 so that the phases thereof coincide with one another.

The output frequency of the VCO 105 is supplied to a receiving section 109 or a transmitting section 110, and is used as a local frequency for data transmission/reception.

When a speaker 108 is activated to emit a sound in order to give a notice of an alarm or an arrival of information, in the case where the notice is given at a fixed frequency, a sound frequency generated by a waveform generation circuit 101C is amplified by a speaker amplifier 106 to activate the speaker 108 to emit a sound.

In the case where the notice is given, not at a fixed frequency but by means of a melody or the like, sound data is transferred to a sound source IC 107 from the CPU section 101A and is amplified by the speaker amplifier 106 to activate the speaker 108 to emit a sound.

In the case where the sound is emitted at a fixed frequency, a square wave, which is synchronized with the sound frequency, is outputted from the waveform generation circuit 101C to a D/A converter section 101B, which in turn adds a predetermined offset value to an ordinary VCTCXO control voltage when the input is “Hi”. The offset value may be an alterable value.

With the above-described arrangement, even when the speaker is activated to emit a sound at a fixed frequency, the phase of the VCTCXO 102 is changed in synchronization with the changes of magnetic flux caused by the sound emission of the speaker. Accordingly, even when the output frequency of the VCO 105 becomes out of phase due to the influence of the changes of the magnetic flux, it is possible to reduce the amount of the phase shift relative to the VCTCXO 102 to a minimum level. Consequently, such effect is obtained that deterioration of radio characteristics such as modulation accuracy or the like can be prevented.

Since the configurations of the above-described receiving section, transmitting section and PLLIC are well known to those skilled in the art, and have no direct relation to the invention, detailed description thereof will be omitted.

Next, the operation of the invention will be described further in detail.

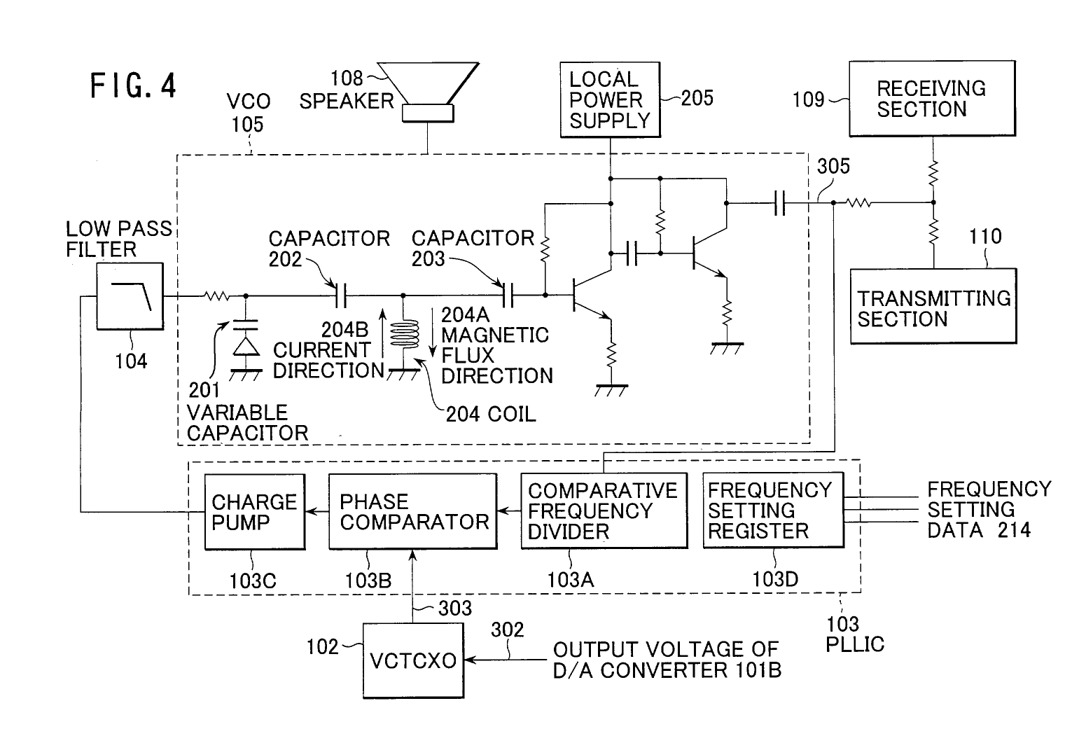

FIG. 4 is a block diagram illustrating details of the local circuit arrangement according to the embodiment of the present invention shown in FIG. 3.

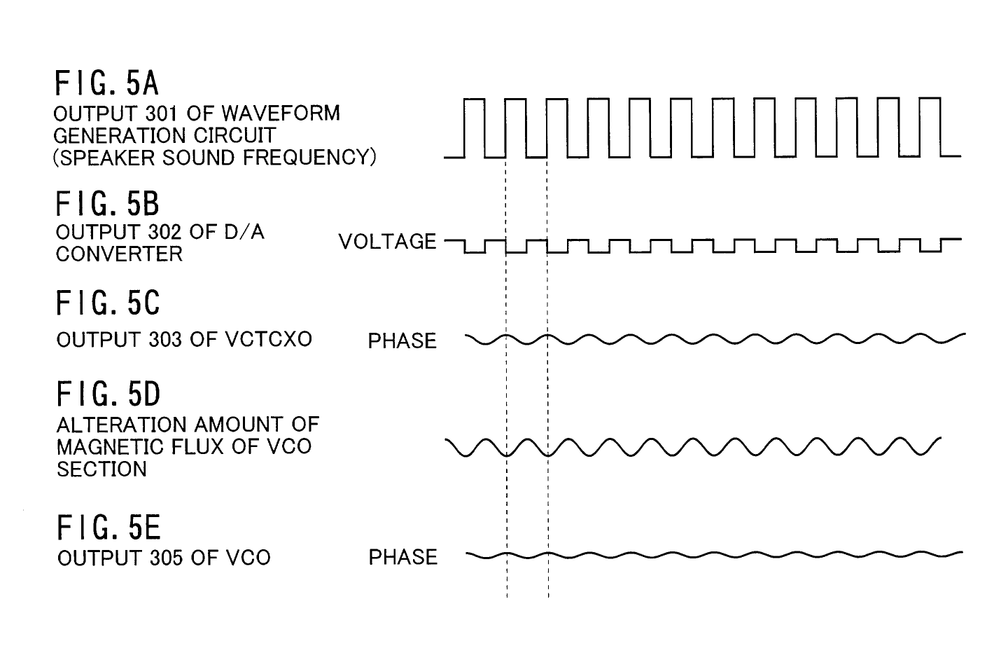

FIGS. 5A-5E show the signals in the respective sections of the circuit arrangement shown in FIG. 3. More particularly, FIG. 5A shows the output 301 of a waveform generation circuit 101C shown in FIG. 3; FIG. 5B shows the output 302 of a D/A converter 101B shown in FIG. 3; FIG. 5C shows the output 303 of the VCTCXO 102 shown in FIG. 3; FIG. 5D shows changes of magnetic flux in the VCO 105, which is generated when the speaker 108 shown in FIG. 3 is activated to emit a sound at a fixed frequency; and FIG. 5E shows the output 305 of the VCO 105 shown in FIG. 3.

The PLLIC 103 controls an output voltage of a charge pump 103C on the basis of frequency-setting data 214 from the control section 101, performs a phase comparison between the frequency obtained by dividing the oscillation frequency 305 of the VCO 105 by a comparative frequency divider 103A and the output frequency 303 of the VCTCXO 102 by means of a phase comparator 103B, and performs a fine control of the output voltage of the charge pump 103C so that the phases thereof coincide with one another.

When the speaker 108 emits a sound at a fixed frequency 301, a change of the magnetic flux is caused in the direction indicated by an arrow 204A with respect to a coil 204 used in an oscillation section of the VCO 105 with the result that current flows in the direction indicated by an arrow 204B due to the electromotive force thereof.

Consequently, the electrostatic capacity of the capacitor 202 and the variable capacitor 201 is increased resulting in decrease in oscillation frequency 305 of the VCO 105. As a result, when the phase of the frequency, which has been subjected to a frequency conversion by the comparative frequency divider 103A, and that of the output frequency 303 of the VCTCXO 102 are compared, shift (lag or delay) is resulted in.

Therefore, according to the embodiment of the invention, it is adapted that, when the output voltage 302 of the D/A converter 101B is changed in synchronization with the sound frequency 301 of the speaker 108 (refer to FIGS. 5A and 5B) and the phase of the output 303 of the VCTCXO 102 is altered (delayed), the amount of the phase shift at the phase comparator 103B becomes relatively smaller. With this arrangement, it is not necessary for the PLLIC 103 to largely adjust the output of the charge pump 103C, so that the phase of the output 305 of the VCO 105 becomes stable (refer to FIG. 5E).

In brief, according to the invention, it is possible, when the speaker is activated to emit a sound at a fixed frequency, to reduce the phase shift of the PLL circuit and to restrain the deterioration of transmitting characteristics at a minimum level by altering the control voltage of the VCTCXO.

As described above, according to the invention, it is possible to provide a mobile terminal equipment having local circuits susceptible to the influence of the magnetic field fluctuation, wherein the mobile terminal equipment is capable of reducing the phase shift of the local circuits even when a magnetic field fluctuation occurs.

Further, according to the invention, when the speaker is activated to emit a sound at a fixed frequency, the phase shift of the PLL circuit is reduced by repeating the fine adjustment of the frequency of the VCTCXO, which is the reference CLK, during the sound emission and the transmission characteristics such as modulation accuracy or the like are improved. With such adjustment, in case of deterioration of transmission characteristics caused by the sound emission of the speaker, the call-in characteristic is improved.

Furthermore, according to the invention, since it is not necessary to take such conventional measures that the speaker is positioned away from the VCO, or a speaker provided with measures against the leak magnetic flux is used and so on, degree of freedom for layout of parts is increased, and since an ordinary speaker can be used, the cost can be reduced.

What is claimed is:

1. A mobile terminal equipment including means for altering reference CLK frequency of a PLL circuit.

2. A mobile terminal equipment including means for altering reference CLK frequency of a PLL circuit in accordance with magnetic field fluctuation in the case where the magnetic field fluctuation occurs at a fixed frequency.

3. A mobile terminal equipment including reference CLK frequency alteration means for altering reference CLK frequency of a PLL circuit in the case where a speaker is activated to emit a sound at a fixed frequency.

4. The mobile terminal equipment according to claim 3, wherein said reference CLK frequency alteration means is adapted to altar the reference CLK frequency of said PLL circuit in synchronization with the sound frequency of the sound emitted by said speaker.

5. The mobile terminal equipment according to claim 3, wherein a voltage controlled temperature compensated crystal oscillator is used as the reference CLK of said PLL circuit.

6. The mobile terminal equipment according to claim 5, wherein said reference CLK frequency alteration means alters said reference CLK frequency by altering control voltage of said reference CLK.

7. The mobile terminal equipment according to claim 6, wherein said reference CLK frequency alteration means alters the control voltage of said reference CLK by adding a specific offset value to an ordinary output value of a D/A converter that outputs the control voltage of said reference CLK.

8. The mobile terminal equipment according to claim 7, wherein said offset value is alterable.

9. The mobile terminal equipment according to claim 3, wherein the reference CLK frequency of said PLL circuit is not altered in the case where said speaker is activated to emit a sound by a means other than a fixed frequency.
